(19) United States
(12) Patent Application Publication
(10) Pub. No.: US 2025/0235970 A1
(43) Pub. Date: Jul. 24, 2025

(54) MACHINE TOOL

(71) Applicant: Schwäbische Werkzeugmaschinen GmbH, Schramberg-Waldmössingen (DE)

(72) Inventor: Marcus MIXNER, Hardt (DE)

(21) Appl. No.: 19/020,490

(22) Filed: Jan. 14, 2025

(30) Foreign Application Priority Data
Jan. 20, 2024 (EP) 24153015.3

(51) Int. Cl. B23Q 7/02; B23Q 1/54; B23Q 1/66

(52) U.S. Cl. CPC B23Q 7/02; B23Q 1/54; B23Q 1/66

(57) ABSTRACT

A machine tool with a machine frame with at least one work spindle, at least one workpiece table, which is mounted in the machine frame so as to rotate or swivel about an axis of rotation, which has a supporting structure including a closed, planar partition wall extending across the entire width of the workpiece table transverse to the axis of rotation and across the entire length of the workpiece table parallel to the axis of rotation and which includes at least one workpiece holder. The workpiece table can be transferred into a separating position in which the partition wall is arranged with its largest surface extending transversely to the associated spindle axis and spatially separates a first area of the workpiece table facing the work spindle, in which a workpiece holder faces the work spindle, from a second area of the workpiece table facing away from the work spindle.

### CROSS-REFERENCE

This application claims the benefit of European application EP 24153015.3 filed Jan. 20, 2024, which is incorporated herein by reference.

The invention is a machine tool.

Machine tools are known from the state of the art in various embodiments and designs. For example, these can include machine frames upon which a workpiece table is arranged, where workpieces can be detachably fastened to a workpiece holder. The workpieces can be processed by a work spindle on the machine tool.

In known machine tools, the workpiece holder is fixed to a workpiece table so that it cannot rotate. In this case, when loading or unloading the workpiece holder of the workpiece table, the work spindle is usually spaced from the workpiece table by a free line of sight. In order to reduce the risk of injury to the operating staff, particularly while loading or unloading the workpiece holder, the work spindle is spaced as far away from the workpiece table as possible in machine tool loading or unloading mode. This provides sufficient installation space in order to guarantee sufficient work safety.

### SUMMARY

One task of an embodiment of the invention is to propose a machine tool in which a distance between the axis of rotation and the work spindle can be reduced.

This task is solved by a machine tool with a machine frame with at least one work spindle, which is pivoted about a spindle axis, with at least one workpiece table which is associated with the at least one work spindle and which is mounted directly or indirectly in the machine frame so as to rotate or swivel about an axis of rotation, which has a supporting structure comprising a closed, planar partition wall extending across the entire width of the workpiece table transverse to the axis of rotation and across the entire length of the workpiece table parallel to the axis of rotation and which comprises at least one workpiece holder which is fixed to the partition wall and/or to the support structure in a rotationally fixed manner, wherein the workpiece table can be transferred by rotation about the axis of rotation into a separating position in which the partition wall is arranged with its largest surface extending transversely to the associated spindle axis and spatially separates a first area of the workpiece table facing the work spindle, in which a workpiece holder arranged therein faces the work spindle, from a second area of the workpiece table facing away from the work spindle.

As the workpiece table of the machine tool comprises a closed, flat partition wall that extends across the entire width of the workpiece table transverse to the axis of rotation and along the entire length of the workpiece table parallel to the axis of rotation, the workpiece holder can be loaded and unloaded in the separating position when the workpiece holder is arranged in the second area of the workpiece table. In this case the partition wall is arranged between the operator and the work spindle and protects the operator. This enables the reduction of the distance between the work spindle and the axis of rotation on the workpiece table while simultaneously meeting the work safety requirements.

One or several workpieces can be attached to the workpiece holder for processing by the at least one work spindle.

Embodiments of the machine tool are conceivable in which the planar partition wall is spaced from the axis of rotation without contact or in which the axis of rotation runs within the partition wall and/or in which the at least one workpiece holder is spaced from the axis of rotation without contact or that the axis of rotation runs within at least one of the at least one workpiece holders.

If the axis of rotation runs without contact to the planar partition wall or the workpiece holder, then rotation is possible about the axis of rotation without imbalance. In this case the axis of rotation can run through the common centre of mass of the partition wall and the workpiece holder.

This proves to be advantageous in particular if only a single workpiece holder is arranged on the workpiece table. In this case the swivel area of the system comprising partition wall and workpiece holder can be reduced.

If the workpiece table comprises several workpiece holders, for example attached on opposite sides of the partition wall, it can prove to be advantageous if the axis of rotation runs within the partition wall. In this case, the swivel area can be kept to a minimum with this arrangement.

In order to ensure that a high level of access to the workpieces to be machined by the work spindle can be guaranteed with the provision of a partition wall on the workpiece table, it is advantageous if the partition wall of the workpiece table comprises at least one continuous opening extending transversely to the axis of rotation, through which the partition wall can be engaged by the work spindle, and a workpiece holder arranged in the loading area is accessible to the engaging work spindle, and if the partition wall comprises at least one planar closure means arranged in or on the at least one opening and which can be transferred from a release position, in which the closure means releases the opening at least in the direction transverse to the axis of rotation in its entirety or in sections, to a closure position, in which the closure means closes the opening in its entirety at least in the direction transverse to the axis of rotation.

As the partition wall comprises a continuous opening that extends transverse to the axis of rotation, the work spindle can protrude through the opening and process a workpiece attached to the workpiece holder, even if the workpiece holder is located in the second area of the workpiece table. This improves the accessibility and the workability of the workpieces attached to the workpiece holder.

As the partition wall comprises at least one planar closure means that releases the opening for gripping in the release position and that closes the opening in the closure position, work safety can be kept high in the loading or unloading mode of the machine tool by transferring the closure means to the closure position.

In this case it proves to be advantageous in particular if the closure element is always arranged in the closure position when the workpiece table is in the separating position.

In addition, the provision of at least one opening in the partition wall enables the workpiece table to be designed compactly, as a small distance between the partition wall and the workpiece holder can be selected without blocking the accessibility of the workpiece holder by the work spindle.

In order to stabilise the transfer of the closure means from the release position to the closed position and vice versa, it proves advantageous if the partition wall in the at least one opening comprises at least one guide, such as a groove or projection, by means of which the transfer of the closure means from the release position to the closed position and back can be guided and secured against movement transverse to the transfer direction and/or if the closure means is designed like a sliding door and comprises at least one flat, in particular plate-like, door element or that the closure means is designed like a roller shutter and comprises several lamellar closure elements.

In principle, it is conceivable that the partition wall comprises a single opening that runs for example in the centre of the partition wall. In order to keep the stability of the partition wall high, it proves to be advantageous if the partition wall comprises a plurality of continuous openings extending transversely to the axis of rotation, which are each spaced apart from one another by bar sections of the partition wall, wherein each opening is assigned its own closure means or wherein at least two openings, in particular all openings of the partition wall, are assigned a common closure means.

In this case it is conceivable, for example, that the partition wall comprises two, four, six or eight openings that are arranged symmetrically identically in the partition wall.

In a further development of the latter embodiment, it proves to be advantageous if the partition wall of the workpiece table comprises at least one central bar section extending parallel to the axis of rotation, through which the axis of rotation runs, and/or at least two edge bar sections extending parallel to the axis of rotation, which form an outer edge of the partition wall, in particular wherein in each case at least two, in particular at least four, openings are arranged between the central bar section and the edge bar section, to each of which a separate or a common closure means is assigned.

In principle it is conceivable that the partition wall and the support structure are separate components that can be separated from one another. In one embodiment of the machine tool it can be provided that the partition wall and the support structure form a single, common component and/or that the central bar section and/or the at least two edge rod sections are designed to be load-bearing and supporting.

If the partition wall and the support structure form a single, common component, then the machine tool can be designed to have reduced components. In this case the at least one workpiece holder is attached directly to the partition wall. In this case, the workpiece holder can be fixed to the partition wall in direct contact with the in partition wall or fixed to the partition wall at a distance from the partition wall by spacer means.

If the partition wall and the support structure form a single, common component it proves to be advantageous if the central bar section and/or the at least two edge bar sections are designed to be load-bearing and supporting.

In this case, forces can be absorbed parallel to the axis of rotation and transferred directly or indirectly to the machine frame.

The alignment of the axis of rotation and the workpiece table can be carried out as desired in principle. In embodiments of the workpiece machine, it is provided that the axis of rotation of the workpiece table runs parallel to a horizontally extending X-axis or parallel to a vertically extending Y-axis and/or that the spindle axis of the work spindle runs parallel to a horizontally extending Z-axis, which runs transverse to the vertically extending Y-axis and transverse to the horizontally extending X-axis.

In principle it is conceivable that a single workpiece holder is arranged in the workpiece table. In addition, in embodiments of the machine tool, it may be provided that the workpiece table comprises at least one first workpiece holder and at least one second workpiece holder, which are arranged non-rotatably on the partition wall and/or on the support structure of the workpiece table on opposite sides of the partition wall with respect to the partition wall.

If the workpiece table comprises at least one first workpiece holder and at least one second workpiece holder, which are arranged on the partition wall and/or on the supporting structure of the workpiece table so as to be non-rotatable with respect to the partition wall on opposite sides of the partition wall, workpieces on the first workpiece holder can be processed by the work spindle parallel to the main time, while the second workpiece holder can be loaded or unloaded with workpieces in the second area. This enables reduction of the processing times of the machine tool.

Furthermore, it is conceivable that several workpiece holders are provided on one side with regard to the partition wall. In this way, for example, at least two first workpiece holders can be arranged at the partition wall on one side with regard to the partition wall and at least two second workpiece holders on the opposite side. In this case, the two first workpiece holders and the two second workpiece holders each run parallel to one another.

In order to ensure that a workpiece holder is always in the same position for working by the work spindle when the workpiece table is transferred by rotating it about the axis of rotation, for example by 180°, it is advantageous if the first workpiece holder and the second workpiece holder are arranged symmetrically, in particular point-symmetrically, with respect to the axis of rotation and are fixed to the partition wall and/or the support structure of the workpiece table so that they cannot rotate.

A compact and so-called interlocked arrangement when two workpiece holders are provided opposite each other can be ensured if the first workpiece holder and the second workpiece holder are arranged in a plane parallel to the separating surface of the partition wall, viewed in a direction transverse to the axis of rotation and offset from each other without overlapping.

This can further reduce the distance between the axis of rotation and the work spindle.

A machine tool can be compactly designed wherein the at least one workpiece table is mounted to rotate or swivel directly on the machine frame and the workpiece table is transferred to the separating position in at least one main time-parallel loading and unloading mode of the machine tool, in which the first area comprises a working area of the workpiece table facing the work spindle, in which a workpiece holder arranged therein faces the work spindle, and in which the second area comprises a loading area of the workpiece table facing away from the work spindle, in which a workpiece holder arranged therein can be loaded and unloaded.

This enables the machine tool to be designed very compactly. As the workpiece table is directly attached to the machine frame mounted to rotate or swivel, the distance between the work spindle and the axis of rotation can be kept very small. This enables the machine tool to be designed with a greatly reduced assembly space.

In order to increase the number of workpieces that can be produced simultaneously, in a further development of the latter embodiment it can be provided that the machine tool comprises at least two workpiece tables which run parallel to one another with respect to their axis of rotation and are spaced apart from one another transversely to the axis of rotation without contact. This means, for example, that when the rotation axis runs horizontally the two workpiece tables can be arranged above one another with regard to the vertical Y-axis and aligned with one another. Furthermore, in the separating position the partition walls of the at least two workpiece tables can continue one another either without gaps or joints and thus separate a work area from the loading area entirely or in sections. If at least two workpiece tables are provided, then it is also advantageous if the machine tool comprises at least two work spindles. In this case, each work spindle is allocated to a workpiece table.

In addition, embodiments are conceivable in which the at least one workpiece table is indirectly attached to the machine frame with a rotating or swivel mounting. Indirectly means that the workpiece table is not directly attached to the machine frame, but rather that there is a further component between the two.

In one embodiment, it is provided that the at least one workpiece table is mounted on a swivel support so as to rotate or swivel, wherein the swivel support is mounted on the machine frame so as to rotate or swivel about a swivel axis and can be transferred from a first swivel position, in which a workpiece table can be arranged in a working area facing the work spindle, into a second swivel position, in which the workpiece table is arranged in a loading area, in which a workpiece holder arranged therein can be loaded and unloaded.

The at least one workpiece table is attached indirectly to the machine frame via the swivel support.

The swivel support can be moved through 180°, for example, from the first swivel position to the second swivel position and back. In order to reduce downtimes during loading and unloading, in a further development of the latter embodiment it is provided that the machine tool comprises at least two workpiece tables which are arranged on opposite sides of the swivel support, wherein a first workpiece table is arranged in the first swivel position of the swivel support in the working area and a second workpiece table is arranged in the first swivel position of the swivel support in the loading area and wherein the first workpiece table is arranged in the second swivel position of the swivel support in the loading area and the second workpiece table is arranged in the second swivel position of the swivel support in the working area.

If a first workpiece table is arranged in the work area, this can processed by the work spindle if the workpiece holder arranged on the first workpiece table is located in the first area of the first workpiece table.

In order to load or unload a workpiece holder of a second workpiece table, it proves to be advantageous if, in this case, the workpiece holder of the second workpiece table is located in the second area of the second workpiece table.

The swivel support can be designed as a frame. In this case a spacial separation of the work area and the loading area can be ensured by arranging the workpiece tables in the separation position.

In addition, it is conceivable that the swivel support itself comprises a swivel support partition wall that is arranged in a swivel support separation position running transverse to the spindle axis of the work spindles and that separates the work area entirely or at least in sections from the loading area.

Further features, details and advantages of the invention are apparent from the appended patent claims, from the drawing and from the following description of three preferred embodiments of the machine tool.

### BRIEF DESCRIPTION OF THE DRAWINGS

The drawing shows:

FIG. 1A sectioned schematic side view of a first embodiment of the machine tool;

FIG. 2A sectioned schematic side view of a second embodiment of the machine tool;

FIG. 3A sectioned schematic side view of a third embodiment of the machine tool;

FIG. 4A schematic perspective top view of the embodiment example according to FIG. 3, without workpiece holder with a second workpiece table.

### DETAILED DESCRIPTION

The figures shows embodiments of a machine tool referred to as a whole with reference number 2. The machine tool 2 comprises both a schematically shown machine frame 4 and a work spindle 6, pivoted around a spindle axis 8. In addition, the machine tool 2 comprises at least one workpiece table 10 associated with at least one work spindle 6, which in the embodiment example shown in the figures is mounted directly on the machine frame 4 so as to rotate or swivel about an axis of rotation 12.

The workpiece table 10 comprises a support structure 14 and a closed, planar partition wall 16. The partition wall 16 extends over the entire width of the workpiece table 10, viewed transversely to the axis of rotation 12, and over the entire length of the workpiece table 10, viewed parallel to the axis of rotation 12.

In addition, the workpiece table 10 comprises a workpiece holder 18, which is fixed to the partition wall 16 and/or to the support structure 14 so that it cannot rotate.

The workpiece table 10 can be moved into a separating position by rotating it about the axis of rotation 12, in which the partition wall 16 is arranged with its largest surface running transversely to the spindle axis 8 of the associated work spindle. Arranged in this way, the partition wall 16 spatially separates a first area 20 of the workpiece table 10 facing the work spindle 6, in which a workpiece holder 18 arranged therein faces the work spindle 6, from a second area 22 of the workpiece table 10 facing away from the work spindle 6. The three embodiments shown in FIGS. 1 to 4 have in common that the axis of rotation 12 of the workpiece table 10 runs parallel to a horizontal X-axis. The spindle axes 8 of the work spindles 6 run parallel to a horizontal Z-axis that runs transversely to the horizontal X-axis and transversely to the vertical Y-axis.

In addition, all embodiments of FIGS. 1 to 4 have in common that openings 24 are arranged in the partition wall 16, which are continuous transversely to the axis of rotation 12. The continuous openings 24 serve to allow the work spindle 6 to reach through the partition wall 16 and process a workpiece, which is fixed in a workpiece holder 18 arranged in the second area 22 of the workpiece table 10, through the opening 24.

In addition, the partitions 16 each comprise flat closure means 26, which are arranged in or on the opening 24 and which can be transferred from a release position, in which the closure means 26 releases the opening 24 in its entirety or in sections at least in the direction transverse to the axis of rotation 12, to a closure position, in which the closure means 26 closes the opening 24 in its entirety at least in the direction transverse to the axis of rotation 12. In the embodiments shown in the figures, the closure means 26 are each arranged in the closed position.

FIG. 1 shows a first embodiment of the machine tool 2. This has a workpiece holder 18, which is mounted to rotate or pivot on the axis of rotation 12 via the support structure 14. The partition wall 16 is arranged opposite the workpiece holder 18. Both the partition wall 16 and the workpiece holder 18 are arranged so that they are contact-free relative to the axis of rotation 12.

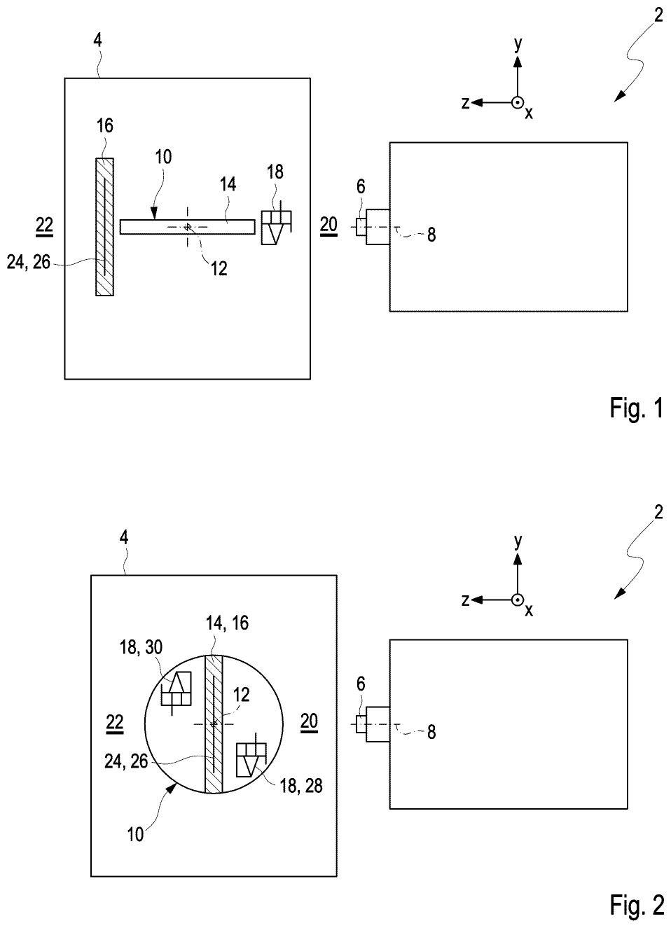

FIG. 2 shows a second embodiment of the machine tool 2, in which two workpiece holders 18 are arranged on a workpiece table 10. The workpiece holders 18 are arranged in such a way that a first workpiece holder 28 is arranged in the first area 20 in the embodiment example shown in FIG. 2 and a second workpiece holder 30 is arranged in the second area 22. The first workpiece holder 28 and the second workpiece holder 30 are spatially separated from each other by the partition wall 16. In addition, the first workpiece holder 28 and the second workpiece holder 30 are arranged in a plane parallel to the separating surface of the partition wall 16, viewed in a direction transverse to the axis of rotation 12, offset from one another without overlapping. Furthermore, the first workpiece holder 28 and the second workpiece holder 30 are arranged point-symmetrically with respect to the axis of rotation 12. This enables an interlocked arrangement.

In the embodiment example shown in FIG. 2, one of the workpiece holders 18 is arranged in the first area 20, which forms a working area. The first workpiece holder 28 of the work spindle 6 is accessible here. In this case, the second workpiece holder 30 arranged in the second area 22 can be loaded or unloaded in a loading and unloading area.

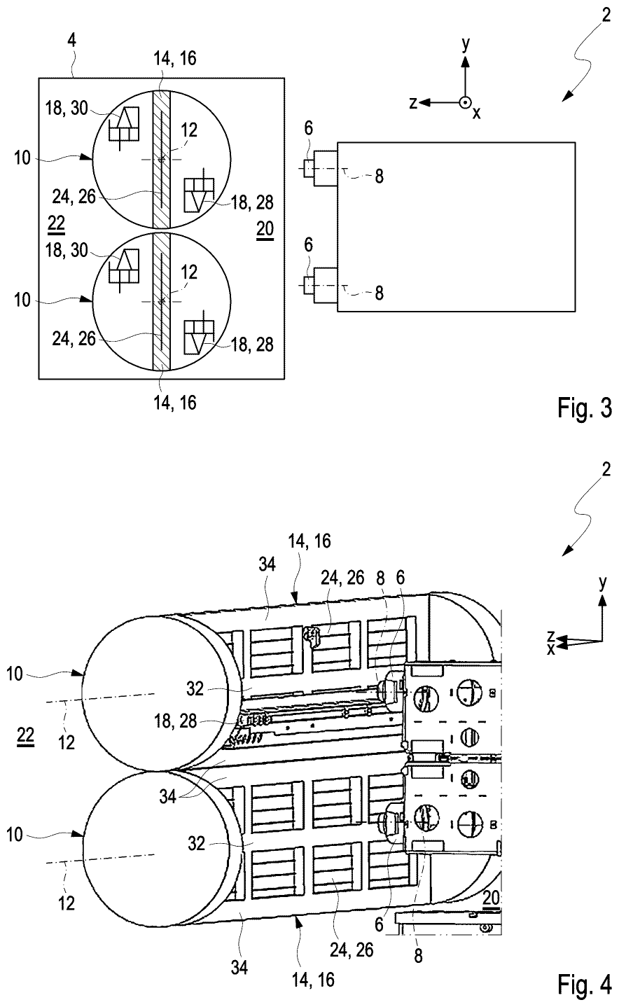

FIG. 3 shows a third embodiment of the machine tool 2. Similarly to the embodiment according to FIG. 2, a workpiece table 10 comprises two workpiece holders 18, namely a first workpiece holder 28 and a second workpiece holder 30 each. In addition, in the embodiment according to FIG. 3, two workpiece tables 10 are provided, which are parallel to each other with respect to their axes of rotation 12 and are spaced apart from each other transversely to the axis of rotation 12 without contact. Both workpiece tables 10 are arranged above one another with regard to the vertical Y-axis and aligned with one another. Each of the workpiece tables 10 here comprise a first workpiece holder 28 and a second workpiece holder 30. A work spindle 6, mounted to rotate about its own spindle axis 8, is allocated to each workpiece table 10.

FIG. 4 shows an isometric front view of the embodiment according to FIG. 3, whereby the first workpiece holder 28 of the lower workpiece table 10 has been hidden. FIG. 4 serves to illustrate the partition wall 16 and its structure in more detail. According to FIG. 4 we can see that the partition wall 16 comprises a central bar section 32 and two edge bar sections 34 extending parallel to it. Between the central bar section 32 and each one of the edge bar sections 34, four openings 24 are arranged, each distanced from one another by one bar. A lamellar closure means 26 is arranged within the openings 24, shown in the illustration according to FIG. 4 in the closure position.

The features of the invention disclosed in the above description, in the claims as well as in the drawing, both individually and in any combination, may be essential in the realisation of the invention in its various embodiments within the scope of protection of the following claims.

### REFERENCE SYMBOL LIST

2 Machine tool
4 Machine frame
6 Work spindle
8 Spindle axis
10 Workpiece table
12 Axis of rotation
14 Support structure
16 Partition wall
18 Workpiece holder
20 First area
22 Second area
24 Opening
26 Closure means
28 First workpiece holder
30 Second workpiece holder
32 Central bar section
34 Edge bar section

1. A machine tool comprising:
a machine frame having at least one work spindle, which is pivoted about a spindle axis,
at least one workpiece table, which is associated with the at least one work spindle and which is mounted directly or indirectly in the machine frame so as to rotate or swivel about an axis of rotation, which has a supporting structure comprising a closed, planar partition wall extending across an entire width of the workpiece table transverse to the axis of rotation and across an entire length of the workpiece table parallel to the axis of rotation and which comprises at least one workpiece holder that is fixed to the partition wall and/or to the supporting structure in a rotationally fixed manner,
wherein the workpiece table can be transferred by rotation about the axis of rotation into a separating position in which the partition wall is arranged with its largest surface extending transversely to an associated spindle axis and spatially separates a first area of the workpiece table facing the work spindle, in which a workpiece holder arranged therein faces the work spindle, from a second area of the workpiece table facing away from the work spindle.

2. The machine tool according to claim 1, wherein the planar partition wall is spaced from the axis of rotation without contact or in which the axis of rotation runs within the partition wall and/or in which the at least one workpiece holder is spaced from the axis of rotation without contact or that the axis of rotation runs within at least one of the at least one workpiece holders.

3. The machine tool according to claim 1, wherein the partition wall on the workpiece table comprises at least one continuous opening extending transversely to the axis of rotation, through which the partition wall can be engaged through by the work spindle, and a workpiece holder arranged in the loading area is accessible to the engaging work spindle, and that the partition wall comprises at least one planar closure means arranged in or on the at least one opening and which can be transferred from a release position, in which the closure means releases the opening at least in the direction transverse to the axis of rotation in its entirety or in sections, to a closure position, in which the closure means closes the opening in its entirety at least in the direction transverse to the axis of rotation.

4. The machine tool according to claim 3, wherein the partition wall in the area of the at least one opening comprises at least one guide by means of which the transfer of the closure means from the release position to the closed position and back can be guided and secured against movement transverse to the transfer direction and/or if the closure means is designed like a sliding door and comprises at least one flat door element or that the closure means is designed like a roller shutter and comprises several lamellar closure elements.

5. The machine tool according to one of the claim 3, wherein the partition wall comprises a plurality of continuous openings extending transversely to the axis of rotation, which are each spaced apart from one another by bar sections of the partition wall, wherein each opening is assigned its own closure means or wherein at least two openings are assigned a common closure means.

6. The machine tool according to claim 5, wherein the partition wall of the workpiece table comprises at least one central bar section extending parallel to the axis of rotation, through which the axis of rotation runs, and/or at least two edge bar sections extending parallel to the axis of rotation, which form an outer edge of the partition wall, wherein in each case at least two openings are arranged between the central bar section and the edge bar section, to each of which a separate or a common closure means is assigned.

7. The machine tool according to claim 1, wherein the partition wall and the support structure form a single, common component and/or that the central bar section and/or the at least two edge bar sections are designed to be load-bearing and supporting.

8. The machine tool according to claim 1, wherein the axis of rotation of the workpiece table runs parallel to a horizontally extending X-axis or parallel to a vertically extending Y-axis and/or that the spindle axis of the work spindle runs parallel to a horizontally extending Z-axis, which runs transverse to the vertically extending Y-axis and transverse to the horizontally extending X-axis.

9. The machine tool according to claim 1, wherein the workpiece table comprises at least one first workpiece holder and at least one second workpiece holder, which are arranged non-rotatably on the partition wall and/or on the support structure of the workpiece table on opposite sides of the partition wall with respect to the partition wall.

10. The machine tool according to claim 9, wherein the first workpiece holder and the second workpiece holder are arranged and aligned symmetrically and are attached non-rotatably on the partition wall and/or the support structure of the workpiece table.

11. The machine tool according to claim 9, wherein the first workpiece holder and the second workpiece holder are arranged in a plane parallel to the separating surface of the partition wall, viewed in a direction transverse to the axis of rotation, offset from one another without overlapping.

12. The machine tool according to claim 1, wherein the at least one workpiece table is mounted to rotate or swivel directly on the machine frame and the workpiece table is transferred to the separating position in at least one main time-parallel loading and unloading mode of the machine tool, in which the first area comprises a working area of the workpiece table facing the work spindle, in which a workpiece holder arranged therein faces the work spindle, and in which the second area comprises a loading area of the workpiece table facing away from the work spindle, in which a workpiece holder arranged therein can be loaded and unloaded.

13. The machine tool according to claim 12, wherein at least two workpiece tables, which are parallel to each other with respect to their axes of rotation and are spaced apart from each other transversely to the axis of rotation without contact.

14. The machine tool according to claim 1, wherein the at least one workpiece table is mounted on a swivel support so as to rotate or swivel, wherein the swivel support is mounted on the machine frame so as to rotate or swivel about a swivel axis and can be transferred from a first swivel position, in which a workpiece table can be arranged in a working area facing the work spindle, into a second swivel position, in which the workpiece table is arranged in a loading area, in which a workpiece holder arranged therein can be loaded and unloaded.

15. The machine tool according to claim 14, wherein at least two workpiece tables, which are arranged on opposite sides of the swivel support, wherein a first workpiece table is arranged in the first swivel position of the swivel support in the working area and a second workpiece table is arranged in the first swivel position of the swivel support in the loading area and wherein the first workpiece table is arranged in the second swivel position of the swivel support in the loading area and the second workpiece table is arranged in the second swivel position of the swivel support in the working area.
